(19) United States
(12) Patent Application Publication
(10) Pub. No.: US 2007/0130532 A1
(43) Pub. Date: Jun. 7, 2007

(54) Hierarchical software navigation system

(76) Inventors: Scott A. Fuller, Greendale, WI (US); Robert J. Alberte JR., Oconomowoc, WI (US); William J. Balloni, Menomonee Falls, WI (US); John H. Radeztsky, Hartland, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/295,102

(22) Filed: Dec. 6, 2005

(51) Int. Cl. G06F 9/00

(52) U.S. Cl. 715/764; 715/853; 715/810; 715/835

(57) ABSTRACT

A hierarchical system for use with a patient monitoring device that controls the amount of display real estate utilized for the navigation system. The system includes a graphical user interface having a navigational interface of a fixed size such that as different menu levels are navigated, the navigational interface does not intrude onto the display for the patient information. The navigational interface includes a plurality of buttons that allow the user to navigate both forward and reverse menu levels without increasing the size of the navigational interface. The graphical user interface including the plurality of navigation buttons is preferably designed for use with a touch screen application.

### BACKGROUND OF THE INVENTION

The development of the graphical user interface (GUI) revolutionized software as a visual dimension was given to the virtual world. With this new, more intuitive means of interacting with software, hierarchical navigation strategies were developed to organize information to be accessed later. The terminology and abstractions used in GUI navigation strategies often have equivalence in the real world of paper materials organization. For example, a file cabinet has a series of drawers. Within each drawer is a series of folders that hold information, in this case, actual paper documents. This real world hierarchical organization of information is used as the model for the organization of information on the GUI into folders, subfolders and contents. This organization of information represents a navigation strategy.

In the clinical setting, clinicians require a large amount of patient information and data to be readily available and conveniently displayed for the purposes of aiding in the proper diagnosis and patient care. Therefore, in the development of graphical user interfaces for a patient monitoring device for use in clinical settings, a large amount of the available display real estate is dedicated to the display of the monitored patient parameters. The amount of information that may be displayed on screen at a single time is fixed by the size of the display as well as the data visibility needs of the clinician.

For example, patient information that a clinician must be able to read and respond to from a distance must be displayed relatively large, thus occupying more display real estate. Patient data entry modalities that require the clinician to utilize a data input device, such as a keyboard which is typically located proximally to the display, can utilize a smaller size of character display, thus allowing more data to be displayed on the screen at any given time.

Due to the multitudes of both collected and archived patient data that a clinician may require for a proper diagnoses and/or patient care, not all of the information can be shown at one time. Therefore, a navigation strategy is needed that allows an operator to easily find and display the desired information.

Current conventional methods of navigation strategy can consume a significant amount of screen real estate, thus decreasing the area available for patient care information. Two types of prior art hierarchical navigation strategies will be addressed, the “menu system” and the “explorer” system, to further point out the limitations of the prior art in the field of patient monitoring.

FIG. 1 illustrates a commonly used hierarchical navigation strategy, which will be referred to as the menu system, utilized in this example by the MS Word® application. The display 10 provides a menu bar 12 comprising a plurality of menu options. The menu bar 12 requires only limited display real estate and displays to the user the names of the menus that may be accessed on the display. When one of the menu buttons 12 is selected, such as the insert button 14 in FIG. 1, the insert menu 16 is displayed on display 10. The full insert menu 16 requires substantially more display real estate than the menu bar 12 alone.

From the insert menu 16, an additional submenu may be selected such as the AutoText menu 18. Furthermore, from the AutoText menu 18, additional third level menus may be selected, such as the Header/Footer third level menu 20. The selection of these menus and submenus increasingly consumes real estate within the display 10. The additional use of display real estate by the series of menus covers up the information displayed by the normal application such that this information is not readily apparent or available to the application user until the menus and submenus have been closed. In a word processing environment, this may not be problematic, since the data on the main display can be obscured. However, in a patient monitoring environment, the patient data cannot be obscured from the clinician for extended periods.

Hierarchical navigation structures are also limited in that the spatial display of the menus and submenus, as each menu 16, submenu 18, and third level menu 20 are oriented on the display 10 to show their relationship to the menu preceding it. Therefore, there is little user control over the location at which each menu and/or submenu will appear within the display 10. Thus, in the field of patient monitoring, the user has little control over what data will be obscured by the opening of these menus and submenus. Finally, the hierarchical navigational strategy displayed in FIG. 1 is limited in that the menus and submenus are “spring loaded” such that if the user wants to make multiple selections within a submenu, such as selecting both the “created by” option 22 and the “created on” option 24, the insert menu and submenus close and the user must go through the required steps to reopen the third level menu 20 to be able to select a second functionality option located within that third level menu.

Referring now to FIG. 2, a second type of display 10 is depicted that is utilizing the “explorer” hierarchical navigation system, such as within the Windows® XP operating system. The navigational interface 26 depicted on the left hand side of display 10 is arranged in a vertical column comprising folders 28, subfolders 30, and third level folders 32. Each of the folders 28a-c may be opened to reveal the subfolders within that folder. In the present example, “Local Disk” 286 can be opened to reveal subfolders 30a-e. Furthermore, subfolder 30b “Documents and Settings” may be opened to reveal third level folders 32. The advantages of the “explorer” navigational system is that the folders, subfolders, and third level folders once opened, remain open. This provides the advantages of menu depth navigation and persistent navigation over the menu based hierarchical structure depicted in FIG. 1.

Menu depth navigation is the strategy in which the operator has the ability to freely access and navigate up and down within the menu hierarchy with the ability to skip levels in the hierarchy if needed. Persistent navigation is the ability for consistent display of the navigational hierarchy after a selection has been made so that a second selection at the same hierarchal depth may be sufficiently made. While the “explorer” navigational strategy provides these benefits over a menu based navigational strategy, the explorer navigational system is limited because the display size of the navigational interface 26 is not constant. The navigational interface 26 expands horizontally as deeper hierarchical levels are navigated and the navigational interface 26 increases vertically as multiple folders are opened in a hierarchical level.

Therefore, especially in a clinical setting where the patient data on the display must be continually viewed, there is a need for a hierarchical navigational system that allows the clinician to easily navigate a complex hierarchical menu system in a way that maximizes the screen real estate that is constantly available for patient information display at any particular time.

### SUMMARY OF THE INVENTION

The present invention solves the previously described problems with hierarchical navigation systems by providing a display real estate efficient hierarchical software navigation system. The system is real estate efficient in that the navigational interface is of a fixed size and facilitates navigation between menu levels. The navigational system of the present invention also provides a comprehensible organizational hierarchy to facilitate navigation within the hierarchy. The present invention further has the advantage of persistent navigation wherein a selected menu level remains open after a selection has been made. Finally, the present invention also lends itself to other areas of software navigation such as touch screen applications or adaptive user interfaces.

The present invention provides a clinical computer system that includes a display having a graphical user interface (GUI) that allows a clinician to access data and application files in one of a series of menu levels arranged in a hierarchical manner. The computer system includes a display for showing both the patient information and menu information. The display includes a display region for graphically depicting patient information from the plurality of data and application files. The display further includes a fixed size navigation interface. The navigation interface has a constant size no matter the menu level being navigated, such that the navigation interface does not expand to cover increasing areas of the display region.

The fixed size navigation interface includes a series of reverse navigation buttons and forward navigation buttons. The reverse navigation buttons allow access to previously navigated menu levels, while the forward navigation buttons allow access to either deeper menu levels or data and/or application files designed to be accessible at the current level. At any time, the navigation interface for the selected menu displays at least a menu level identified, reverse navigation buttons that display the navigational path required to access the current level and forward navigation buttons to access deeper menu levels. Further, each menu level display preferably includes functionality buttons associated with the current level being displayed.

Each menu level displayed within the fixed size navigation interface preferably includes a series of control buttons that remain displayed regardless of the current menu level selected. The common control buttons allow the user to carry out common functions regardless of the menu level.

The graphical user interface thus presents the required functionality for the user while occupying only a fixed region within the display for the clinical computer system. Thus, as the menu levels change, the fixed size navigation interface does not obscure additional area on the patient display, as is the case with other prior art navigational systems currently available.

### BRIEF DESCRIPTION OF THE DRAWINGS

FIG. 1 depicts a prior art screen shot menu navigational system as used in Microsoft Word®;

FIG. 2 depicts a prior art screen shot of the Explorer navigational system as used in Microsoft XP®;

FIG. 3 is a view of a graphical user interface utilizing the hierarchical software navigation system of the present invention;

FIG. 4a depicts the top level of the navigational interface of the present invention;

FIG. 4b depicts the first level of the navigational interface of the present invention; and

FIG. 4c depicts the second level of the navigational interface of the present invention.

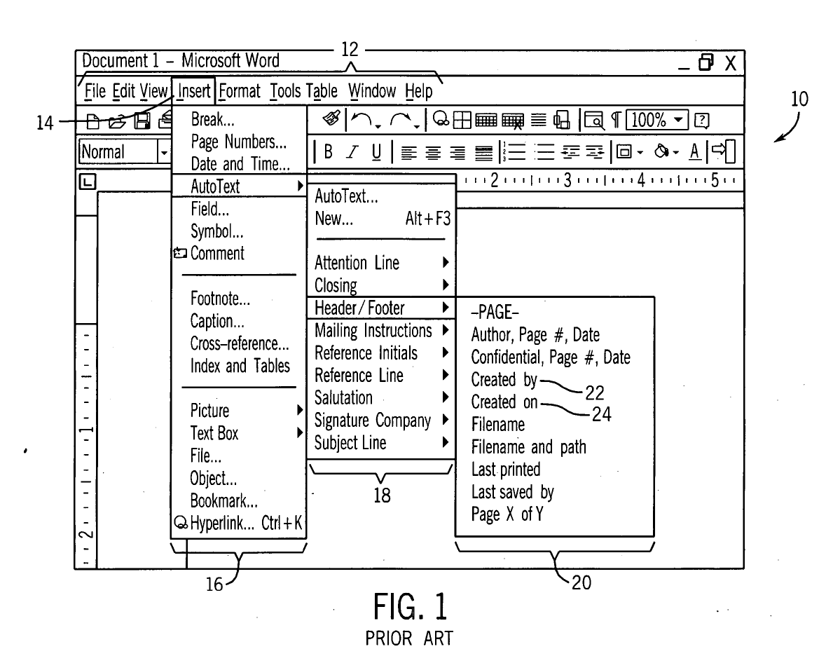

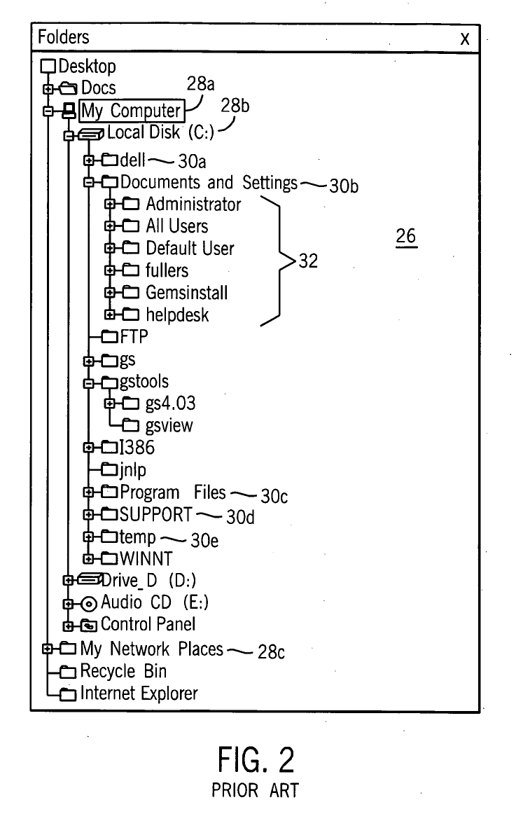

### DETAILED DESCRIPTION OF THE PREFERRED EMBODIMENT

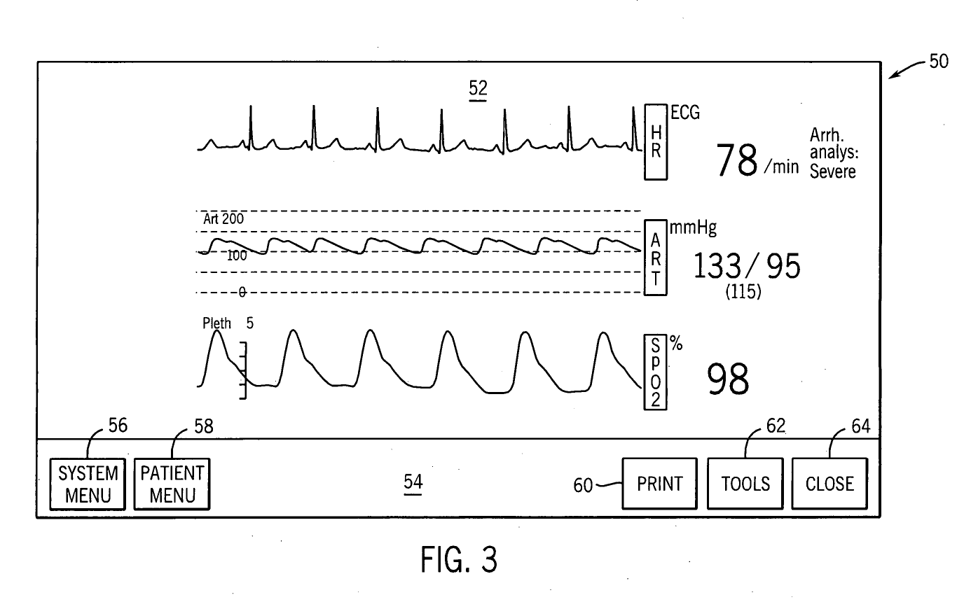

FIG. 3 shows a graphical user interface (GUI) 50 that is primarily intended for use in patient monitoring, such as in a medical care facility. GUI 50 consists of a display region 52 upon which medical data and information may be display to a clinician. In a medical setting, the amount of potential patient data and information that a clinician may desire to access to aid in treatment and/or diagnosis is vastly larger than may be displayed on display region 52 at a single time. This data may consist of real time patient signals, quantified patient parameters and/or patient information or history.

In order to access the patient information that is not currently being displayed, a navigational interface 54 is provided upon the display 50. In the embodiment of the invention shown, the navigational interface 54 is shown at the bottom of the display region 52, although it could be located at other positions. The navigational interface 54 is of a fixed size and therefore the display of the patient information and data in display region 52 will not be affected at any time due to the clinician's navigation through the hierarchical organization of patient data and device functionalities. This feature of the invention insures that the patient data and information that has been selected to be displayed continues to be displayed despite the navigational activities of the clinician.

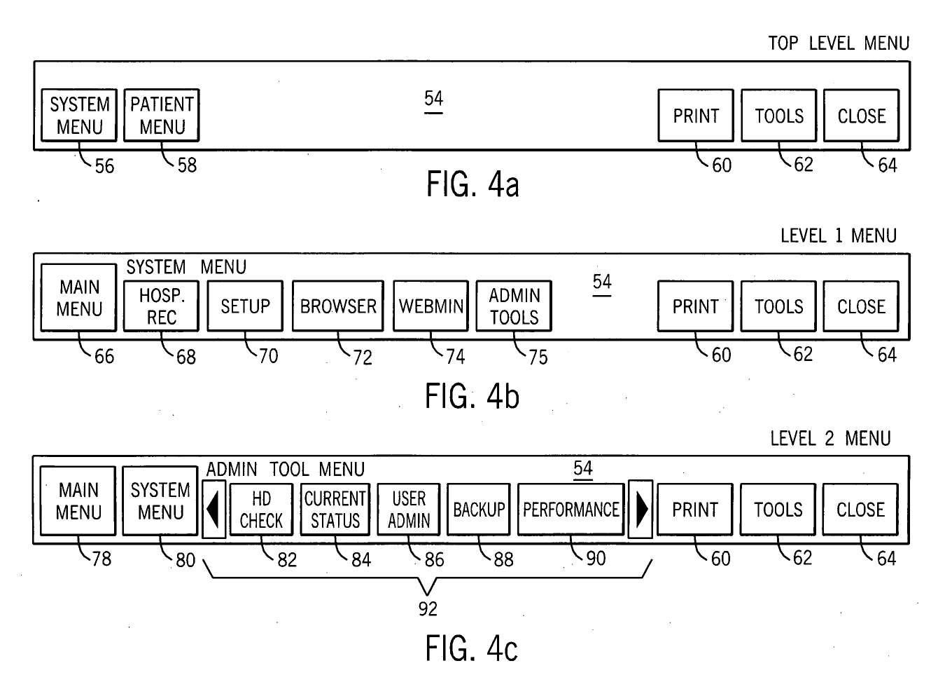

Referring now to FIGS. 4a-c, FIG. 4a depicts the top or starting level of the hierarchical navigational system of the present invention. At the top navigational level, a plurality of individual buttons are displayed to the clinician. These buttons consist of forward navigation buttons, such as the system menu button 56 and the patient menu button 58. The forward navigation buttons may be selected by the clinician to navigate to the next deeper level of the menu within the hierarchical organizational system. On the top navigational level depicted in FIG. 4a, a plurality of control buttons are also displayed, such as Print 60, Tools 62 and Close 64. These buttons are of common functionality regardless of the present menu level within the hierarchical organizational structure, and as such, are available for each of the current level menus selected. After a forward navigation button has been selected, in this case the system menu button 56, a level 1 menu, as depicted in FIG. 4b, will be displayed on the navigational interface 54.

The level 1 menu includes a reverse navigation button 66, which if selected, would take the clinician back to the main menu illustrated in FIG. 4a. The level 1 menu also includes a plurality of forward navigation buttons, here depicted as a Hospital Resource button 68, a setup button 70, a Browser button 72, a Webmin button 74 and an Admin Tools button 76. The selection of any of these buttons will take the user to the next deeper level menu within the hierarchical organizational structure. The common control buttons 60, 62, and 64 are also still available to the clinician while navigating at this level. Upon selection of one of the forward navigation buttons by the clinician, the navigational interface will then display a level 2 menu, such as depicted in FIG. 4c, in the same navigational interface 54.

The level 2 menu is comprised of the common control buttons 60,62,64 previously seen in the top level and the level 1 menus, as well as forward navigation buttons, here depicted as buttons 82-90. The reverse navigation buttons are also depicted in the level 2 menu, however, since the level 2 menu has two menu levels about it, there are two reverse navigation buttons, one for the main menu 78 and one for the system menu 80. The selection of either of these buttons by the clinician will take the clinician back to that menu level within the hierarchical organizational system. By providing both of these reverse navigation buttons, the clinician is free to have access to navigate up and down in the menu hierarchy, and the clinician may skip layers within the hierarchy to access a previous menu level. This allows the clinician a certain amount of random access navigation. This random access navigation promotes the efficiency of the overall navigational system.

The level 2 menu, shown in FIG. 4c, comprises a plurality of functionality buttons. These functionality buttons are the means with which the clinician has access to the patient data and/or applications to be displayed on the display region 52. These functionality buttons may include, as depicted, HD Check 84, Current Status 86, User Admin 88, and Backup 90 buttons. One advantage of the present invention is the static nature of the selected level menu in that after a selection of one functionality button has been made, that level menu remains open, thus promoting the efficiency of the clinician in selecting a second functionality from the same level menu. Additionally, if the level menu comprises more forward navigation and/or functionality buttons than may be displayed in the navigational interface 54, scrolling buttons 92 may appear to facilitate the clinician's ability to easily access the additional forward navigation buttons and/or functionality buttons while maintaining a constant amount of display 50 real estate that is dedicated to the navigational interface 54.

As described, the hierarchical navigation system of the present invention, as shown in FIGS. 4a-c, includes a constant size navigation interface 54 that includes a series of buttons that allow the clinician to navigate either forward or backward within the menu structure. In the embodiment of the invention illustrated in FIGS. 4a-c, each level of the menu display includes a series of reverse navigational buttons that allow the clinician to return directly to any previous menu level without having to scroll through multiple levels. In addition, each menu level includes forward navigational buttons that allow the clinician to either select additional menu levels or directly access information/data from the presently displayed menu level.

In the embodiment shown in FIG. 4, only two level menus are shown below the top level menu. However, it should be understood that the hierarchical navigation system could include multiple levels below the level two menu shown in FIG. 4c. In such a system, each menu level will include both forward and reverse navigational buttons to allow the clinician to easily navigate through the different menu levels. In each case, the level menus remain a constant size and consume only a fixed amount of display real estate without covering the displayed patient information.

A further aspect of the present invention is that the size of the buttons within the navigational interface 54 may be easily expanded to be larger than those navigational interface buttons seen in other prior art hierarchical navigational systems. The potential for the increased size of these buttons allows for greater compatibility of this system with touch screen formats that are currently employed and have gained widespread popularity within many fields, including the medical field. The larger size of these buttons facilitates the clinician in digitally making navigational selections within the hierarchical organizational system. Also, the potential for the increased size of the navigational buttons also provides a benefit in adaptive applications for users who may benefit from the larger, and more visible, navigational buttons, such as visually impaired users.

While the description of the present invention has been directed towards a medical device or for use in a clinical setting, this is understood to be merely exemplary and it is further understood that the navigational system of the present invention may be implemented in any organizational hierarchy software setting.

What is claimed is:

1. A clinical computer system including a display having a graphical user interface (GUI) and a plurality of data and application files arranged according to an associated menu level in a hierarchical manner, the computer system comprising:
a display region for graphically depicting patient information from the plurality of data and application files;
a fixed size navigation interface contained on the display, the navigation interface having a plurality of used activated buttons, the plurality of buttons being selected from a list of buttons comprising reverse navigation buttons to allow access to a previously navigated menu level, forward navigation buttons to allow access to a deeper menu levels, and functionality buttons to allow the clinician to select a data or application file;
wherein when a menu level is selected, the navigation interface includes at least a menu level identifier, reverse navigation buttons that display the navigational path required to access the current level, and the forward navigation buttons and functionality buttons associated with the current level.

2. The clinical computer system of claim 1 wherein the GUI is a touch screen.

3. The clinical computer system of claim 1 further comprising common control buttons that remain displayed in the navigation interface regardless of the current menu level.

4. The clinical computer system of claim 1 wherein the navigational interface retains its current state after the selection of a functionality button.

5. The clinical computer system of claim 1 further comprising a menu level identifier, wherein said menu level identifier displays to the user the current level displayed within the hierarchy.

6. The clinical computer system of claim 1 wherein the navigational interface is a substantially small portion of the entire GUI.

7. The clinical computer system of claim 1 further comprising user-selectable scrolling buttons each operable to display additional buttons that are associated with the current menu level.

8. The clinical computer system of claim 1 wherein the clinician may select the reverse navigational button associated with any of the previously navigated menu levels.

9. A graphical user interface (GUI) for a patient monitoring device arranged to display patient information and access a plurality of data and application files assigned to an associated menu level organized in a hierarchical manner, the graphical user interface comprising:
a display region for graphically depicting patient information retrieved from the plurality of data and application files;
a fixed size navigation interface contained on the display, the fixed sized navigation interface including a plurality of user selectable buttons to permit the navigation of the menu levels, wherein when a menu level is selected, the navigation interface includes at least a menu level identifier, reverse navigation buttons to allow access to a previously navigated menu level, forward navigation buttons to allow access to a deeper menu level and functionality buttons associated with the current level.

10. The graphical user interface of claim 9 wherein the reverse navigation buttons, forward navigation buttons and functionality buttons are displayed on a touch screen.

11. The graphical user interface of claim 10 wherein the navigation interface includes a plurality of common control buttons that remain displayed in the navigation interface for all of the menu levels.

12. The graphical user interface of claim 9 wherein the display region is substantially larger than the fixed size navigation interface.

13. The graphical user interface of claim 9 wherein the fixed size navigation interface includes a varying number of buttons depending upon the selected menu level.

14. The graphical user interface of claim 9 wherein the navigation interface for each menu level includes reverse navigational buttons associated with each of the previously navigated menu levels.
